(19) United States
(12) Patent Application Publication
(10) Pub. No.: US 2007/0081715 A1
(43) Pub. Date: Apr. 12, 2007

(54) Quality control system and method for moving web material

(76) Inventors: Michael Chaput, Merrimack, NH (US); Willard Lucey, Merrimack, NH (US); Charles Malony, Milford, NH (US)

Correspondence Address: THOMPSON HINE L.L.P., P.O. BOX 8801, DAYTON, OH, 45401-8801, US

(21) Appl. No.: 11/542,427

(22) Filed: Oct. 3, 2006

Related U.S. Application Data
(60) Provisional application No. 60/724,146, filed on Oct. 6, 2005.

(51) Int. Cl. G06K 9/00

(52) U.S. Cl. 382/152

(57) ABSTRACT

A method for inspecting moving web material on a label application unit is provided. The web material includes repeated, pre-printed sections wherein each section corresponds to an individual package unit. The method includes detecting a position indicator located on the web material using a sensor where multiple sections of the moving web material includes a position indicator. A die section is moved in response to detection of the position indicator to re-position the die section for a cutting operation. It is determined whether movement of the die section is beyond a predetermined range using a processor. One or more of the method steps are repeated for more than one pre-printed section of the moving web material.

### CROSS-REFERENCE TO RELATED APPLICATIONS

The present application claims priority to provisional U.S. application Ser. No. 60/724,146, filed Oct. 6, 2005, the content of which is hereby incorporated by reference as if fully set forth herein.

### TECHNICAL FIELD

The present application relates to a quality control system and method for inspecting moving pre-printed web material.

### BACKGROUND

Many products are supplied in sealed bags, pouches or other packages formed from thin films or other flexible materials. For example, foodstuffs, tobacco products, small parts or loose items such as pharmaceuticals or other medical accessories are commonly provided in pouches or bags formed from flexible film material.

The production of these products is carried out by forming such products as elongated webs which are thereafter segmented by cutting to yield lengths which are usable by the customer. While the character of the material along the length of the web may appear to be uniform, in many instances there are variations along the length of such webs. These variations may arise for example in the form of instantaneous or running defects within the material forming the web.

Methods of inspecting web material following production have been developed to identify the location and nature of variations along the length of the web material. A continuous, non-stop inspection method is needed to reduce process downtime.

### SUMMARY

In an aspect, a method for inspecting moving web material on a label application unit is provided. The web material includes repeated, pre-printed sections wherein each section corresponds to an individual package unit. The method includes detecting a position indicator located on the web material using a sensor where multiple sections of the moving web material includes a position indicator. A die section is moved in response to detection of the position indicator to re-position the die section for a cutting operation. It is determined whether movement of the die section is beyond a predetermined range using a processor. One or more of the method steps are performed for more than one pre-printed section of the moving web material.

In another aspect, a system for inspecting moving web material on a label application unit includes a first scanner arranged and configured to sense a position indicator carried by the moving web material. A second scanner is arranged and configured to sense a pre-printed mark. A sensor is arranged and configured to sense an edge of the moving web material. A detector is arranged and configured to detect an increase in web thickness as the moving web material passes thereby. A controller receives signals from at least one of the first scanner, second scanner, sensor and detector.

Other advantages and features of the invention will be apparent from the following description of particular embodiments and from the claims.

### BRIEF DESCRIPTION OF DRAWINGS

FIG. 1 is a front view of an embodiment of a label application apparatus including quality assurance points;

FIG. 2 is an embodiment of a method used to provide quality assurance and/or inspection of web material as the web material moves through the label application apparatus of FIG. 1;

FIG. 3 is a top view of section 3 of the label application apparatus of FIG. 1;

FIG. 4 is a top view of an embodiment of a label;

FIG. 5 is a top view of section 5 of the label application apparatus of FIG. 1; and

FIG. 6 is a diagrammatic front view of an embodiment of a wrinkle detection assembly.

### DESCRIPTION

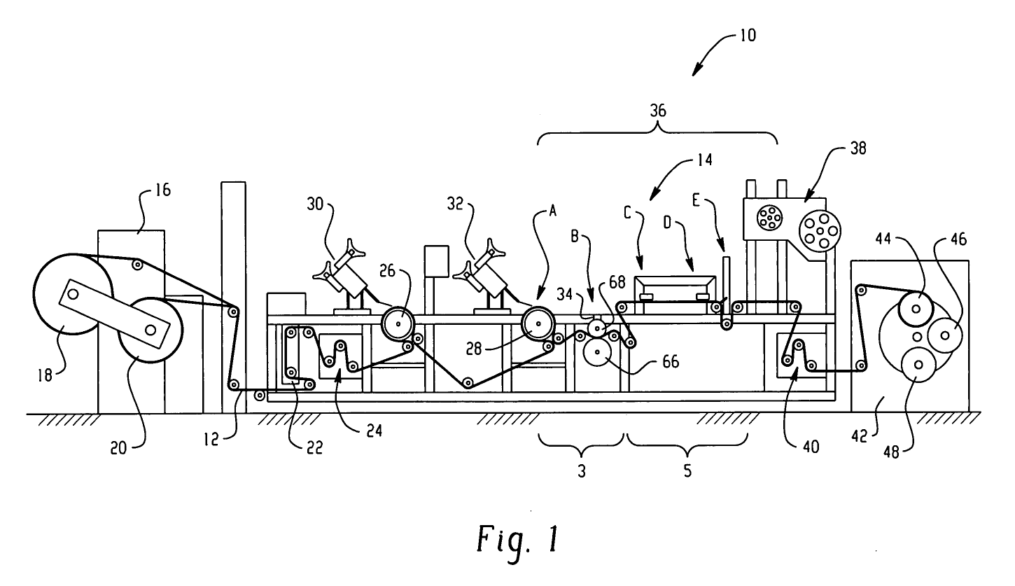

Referring to FIG. 1, a label application system and apparatus 10 is used, in the illustrated embodiment, to place label elements onto a web material 12. The web material 12 includes multiple, pre-printed and repeated sections that may be used to form individual flexible pouches or bags (e.g., by separating the sections and forming the pouches or bags during a downstream forming process). As will be described in greater detail below, the apparatus 10 includes a quality control system, generally designated as 14, having multiple quality assurance points A-E that are used to reduce the occurrence of and identify defects that may occur, for example, due to printing variations on the moving web material 12. It should be noted that the label application unit 10 is exemplary only and should not be considered as unduly limiting as features described herein may have application in conjunction with other automated application processes.

Label application apparatus 10 includes an unwind unit 16 (e.g., commercially available from Kenne Technology, Inc. (KTI), Beloit, Ill.) where rolls 18 and 20 of pre-printed web material are continuously spliced in register (e.g., tolerance of +/−0.125 inch) followed by an edge reading ultrasonic web guide 22 (e.g., commercially available from AccuWeb, Inc., Madison, Wis.). After passing through a nipped infeed tensioning dancer 24, the web material 12 wraps around two 12 inch drums 26 and 28, where at one of either of the two 12 inch drums, a label head 30, 32 (e.g., commercially available from Quadrel Labeling Systems, Inc., Mentor, Ohio) using a printed eye mark (described below) will apply a label. The two label heads 30, 32 operate in tandem to provide a non-stop application. However, only one label head or more than two label heads may be used.

After the label application, the web material 12 is die cut in register to the printed eye mark from the underside at a die cut station 34. The web material 12 passes through a quality assurance section 36, described below, a flagging label head 38, an exit nipped pacing roll 40 and a turret rewind 42. Finished product rolls 44, 46, 48 are spliced in register on a turret rewinder (e.g., commercially available from KTI), at a designated footage.

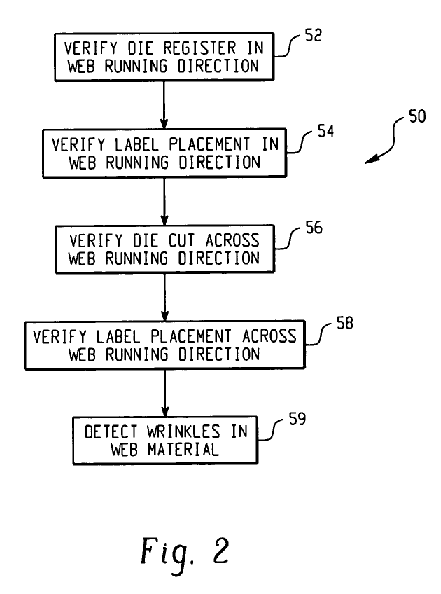

Referring now to FIG. 2, a quality control method 50 is used to provide quality assurance or inspection of the web material 12 as the web material moves through the label application apparatus 10. The quality control method 50 includes verifying die register in the web running direction at step 52, verifying label placement in the web running direction at step 54, verifying die cut across the web running direction at step 56, verifying label placement across the web running direction at step 58 and/or detecting wrinkles in the web material at step 59.

A. Die Register In Web Running Direction

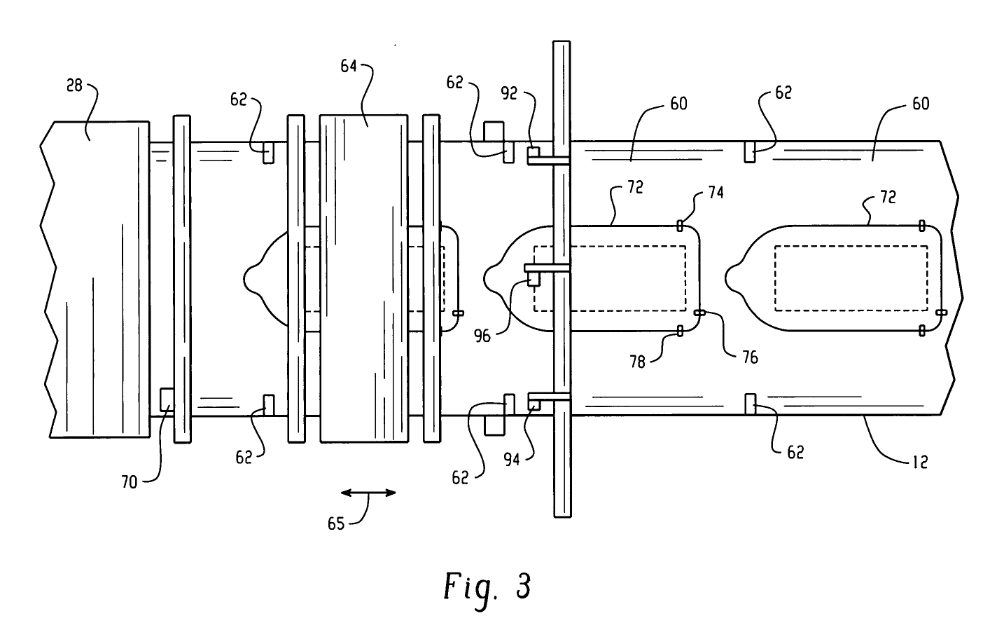

Referring to FIG. 3, in one embodiment, each repeated section 60 of the web material 12 includes two pre-printed blocks or eye marks 62 located at opposite edges of the web material. In the illustrated example, the eye marks 62 are located directly across the web material 12 from each other. The eye marks 62 are a color (e.g., white) in contrast to the color of the web material 12 (e.g., red). As indicated above, each section 60 of web material 12 represents a bag or pouch.

In operation, die section 64 (e.g., servo controlled die 66 and anvil 68; see FIG. 1) of die cut station 34 is verified to be held to a predetermined tolerance (e.g., +/−0.1875 inch) from a standard. An optical contrast scanner 70 (or die register sensor) reads one of the eye marks 62 in order to determine position of the web material 12. The determined position is compared to a theoretical expectancy of the eye mark 62 that is related to the number of teeth (e.g., 160 teeth, ⅛ inch CP) of the die 66. Depending on this comparison, the die section 64 may or may not be moved in the web running direction shown by arrow 65. In one embodiment, the correction of the die section 64 is limited to a maximum tolerance (e.g., +/−0.1875 inch). Any correction of the die section 64 greater than the maximum tolerance will be marked as “out of process window” and a signal may be sent, for example, to a programmable logic controller (e.g., commercially available from Allen Bradley).

B. Label Placement In Web Running Direction

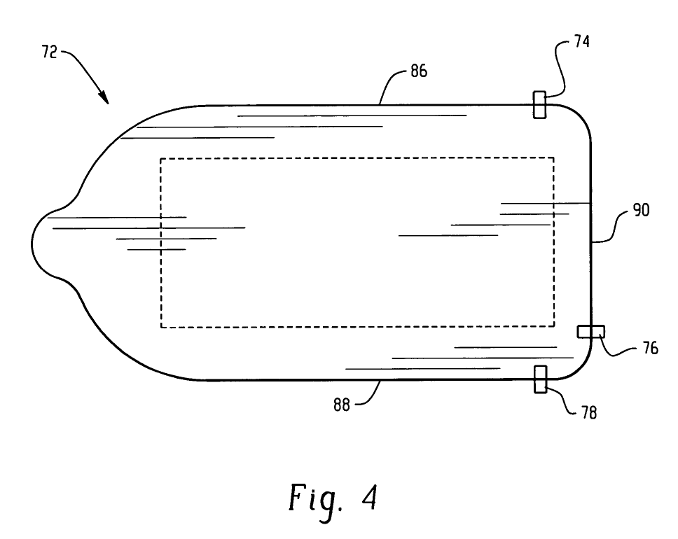

Referring also to FIG. 4, a label 72, which may be clear, includes blocks 74, 76 and 78 of varnish with a given fluorescent level printed on the label 72. The blocks 74, 76 and 78 are used to locate the label 72 at different locations (e.g., top 86, bottom 88 and leading edge 90). The placement of the label 72 in the web running direction is toleranced a predetermined amount (e.g., +/−0.1875 inch) from a standard and is referenced to the eye marks 62 on either edge of the web material 12.

Optical contrast scanners 92 and 94 are offset from each other in the web running direction (e.g., 0.375 inch) to create a label sensor gate. A luminescence scanner 96 (e.g., such as a QL55 microprocessor-controlled luminescence sensor, commercially available from Banner Engineering Corp.) is located in the web running direction between the scanners 92 and 94 to detect the leading edge varnish block 76.

In operation, optical contrast scanner 92 detects one of the eye marks 62 as the eye mark 62 passes thereunder, which opens the gate. The luminescence scanner 96 then reads the leading edge varnish block 76 in order to determine the position of the label. Then, the optical contrast scanner 94 reads the second eye mark 62, which closes the gate. The information is fed to the PLC and is processed to track each repeat section of the web material 12. If the gate closes before the luminescence scanner reads the leading edge of the varnish block, then the tolerance will be marked “out of process window” or the label is missing and a corresponding signal is sent to the PLC.

C. Die Cut Across Web Running Direction

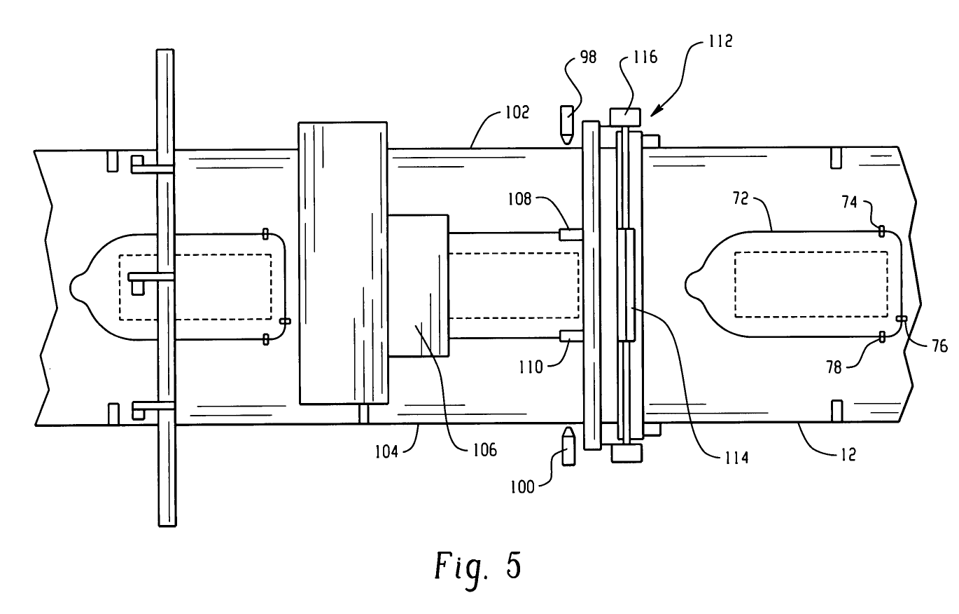

Referring to FIG. 5, die section 64 is fixed in a frame such that it is moveable in the web running direction, but not moveable transverse to the web running direction. The web material 12 may, however, itself weave or at least temporarily shift in the cross web running direction, moving the die cut out of a specified tolerance (e.g., +/−0.125 inch from a standard). Sensors 98 and 100 (e.g., capacitance sensors, commercially available from Balluff, Inc., Florence, Ky.) are located to monitor the position of the web material 12 by looking for the web running direction edges 102, 104 of the web material. The sensors 98 and 100 are positioned to allow movement of the web material in the cross web running direction a specified tolerance (e.g., +/−0.125 inch from a standard). Movement of the web material 12 out of this tolerance will cause one of the sensors 98, 100 to provide a signal to the PLC and the corresponding section of the web material will be marked “out of process window.”

In some embodiments, an imager, such as camera 106 (e.g., commercially available from Handy Scan) may be used to inspect the quality assurance functions at various repeat sections of web material 12. In some embodiments, this inspection may not be continuous. For example, the web material 12 may be moving in the web running direction at approximately 250 feet per minute and every other section of web material monitored with the camera 106. In one embodiment, the camera 106 takes still pictures every other repeat section and those pictures are monitored by an operator of the apparatus 10.

D. Label Placement Across Web Running Direction

Referring briefly to FIG. 4, top varnish block 74 and bottom varnish block 78 are used to control the tolerance of label 72 placement in the cross web running direction. Referring again to FIG. 5, luminescence scanners 108 and 110 are mounted to gate a window in which the label must pass without detection of one of the varnish blocks 74 and 78. If a scanner 108, 110 detects one of the varnish blocks 74, 78, a signal is sent to the PLC and the label 72 is considered to be “out of process window.”

E. Wrinkle Detection

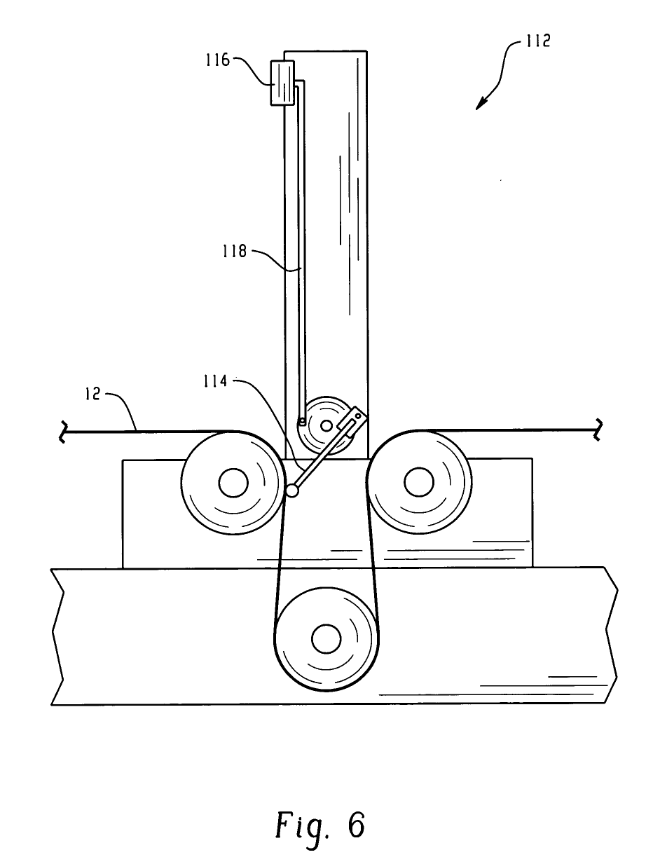

A wrinkle detection assembly 112 is used to detect regions of increased web material thickness. Referring to FIG. 6, wrinkle detection assembly 112 includes a plate 114 that is biased toward the web material 12 (e.g., by a spring). A sensor 116 (e.g., a laser scanner) monitors movement of a lever arm 118 that is connected to the plate 114. The sensor 116 provides a signal to the PLC indicative of deflection of the lever arm 118. The lever arm 118 is used to amplify movement of the plate 114, which in turn amplifies the signal provided by the sensor 116. In one embodiment, if the plate 114 deflects more than 0.002 inch, such as 0.004 inch or more, then a signal is sent to the PLC and the corresponding section of web material 12 is determined to have a wrinkle.

In some embodiments, the PLC program runs a cascade ladder, which tracks each repeat of the web material 12 through the quality control method 50 to the flagging or defect label, label head 38 (FIG. 1). If during the process a defect at any of the quality assurance points A-E occurs, that repeat section is flagged or marked with a defect label at label head 38. In some embodiments, a green label is placed on each defective repeat section. In some implementations, information regarding the defect is displayed on an operator display for review by an operator. The quality assurance portion of the computer program has programmable gates to stop the apparatus 10 for both rate occurrence and total occurrence per roll. Further, the system is programmable so that, for example, if a certain number of defects or flags occur for a predetermined length of web material 12 (e.g., three defects within 20 feet of web material), then the label application apparatus 10 can be shut-down for correction.

It is to be clearly understood that the above description is intended by way of illustration and example only and is not intended to be taken by way of limitation, and that changes and modifications are possible. Accordingly, other embodiments are contemplated and modifications and changes could be made without departing from the scope of this application as expressed by any claims now included or hereafter added.

What is claimed is:

1. A method for inspecting moving web material on a label application unit, the web material including repeated, pre-printed sections wherein each section corresponds to an individual package unit, the method comprising:
(a) detecting a position indicator located on the web material using a sensor, multiple sections of the moving web material including a position indicator;
(b) moving a die section in response to detection of the position indicator to re-position the die section for a cutting operation;
(c) determining whether movement of the die section is beyond a predetermined range using a processor; and
(d) performing steps (a)-(c) for more than one pre-printed section of the moving web material.

2. The method of claim 1 further comprising marking the respective pre-printed section if the processor determines that movement of the die cutter is beyond a predetermined range in step (c).

3. The method of claim 1 further comprising
placing a label on the web material; and
verifying label placement in a web running direction.

4. The method of claim 3, wherein the label is a transparent film having a top edge, a bottom edge opposite the top edge and a leading edge.

5. The method of claim 4, wherein the label includes a pre-printed varnish mark.

6. The method of claim 5, wherein the label includes a first varnish mark located near the top edge, a second varnish mark located near the bottom edge and a third varnish mark located at the leading edge.

7. The method of claim 6 further comprising verifying label placement across web running direction using at least one of the first and second varnish marks.

8. The method of claim 1 further comprising detecting an edge of the moving web material using a detector, the detector providing a signal when the edge is detected.

9. The method of claim 8 further comprising marking the respective pre-printed section if the edge of the moving web material is detected.

10. The method of claim 9, wherein the edge of the moving web material extends in a web running direction.

11. The method of claim 10 further comprising detecting an opposite edge of the moving web material using a detector, the detector providing a signal when the opposite edge is detected.

12. The method of claim 1 further comprising detecting wrinkles in the web material and marking the respective pre-printed section of the web material if a wrinkle is detected.

13. A system for inspecting moving web material on a label application unit, comprising:
a first scanner arranged and configured to sense a position indicator carried by the moving web material;
a second scanner arranged and configured to sense a pre-printed mark;
a sensor arranged and configured to sense an edge of the moving web material;
a detector arranged and configured to detect an increase in web thickness as the moving web material passes thereby; and
a controller that receives signals from at least one of the first scanner, second scanner, sensor and detector.

14. The system of claim 13, wherein the first scanner is an optical contrast color scanner.

15. The system of claim 13, wherein the second scanner is a luminescence scanner.

16. The system of claim 13, wherein the sensor is a capacitance sensor.

17. The system of claim 13, wherein the detector comprises a swing plate arranged and configured to deflect to detect the increase in web thickness.

18. The system of claim 13, wherein the controller verifies die register in a web running direction using the first scanner, verifies label placement in the web running direction using the second scanner, verifies die cut across the web running direction using the sensor and detects wrinkles in the web material using the detector.

19. The system of claim 13 further comprising third and fourth luminescence scanners located downstream from the first scanner.

20. The system of claim 13 further comprising an imager disposed above the web material for visually inspecting the web material.
